(19) United States
(12) Patent Application Publication
(10) Pub. No.: US 2015/0019112 A1
(43) Pub. Date: Jan. 15, 2015

(54) CONTROL DEVICE FOR INTERNAL COMBUSTION ENGINE

(71) Applicant: Hitachi Automotive Systems, Ltd., Hitachinaka-shi, Ibaraki (JP)

(72) Inventors: Takuya Shiraishi, Tokyo (JP); Kengo Kumano, Tokyo (JP); Kenichiroh Ogata, Tokyo (JP); Yoshihiko Akagi, Hitachinaka (JP); Shinya Matohara, Hitachinaka (JP)

(73) Assignee: Hitachi Automotive Systems, Ltd., Hitachinaka-shi, Ibaraki (JP)

(21) Appl. No.: 14/379,682

(22) PCT Filed: Feb. 6, 2013
(86) PCT No.: PCT/JP2013/052654

§ 371 Date: Aug. 19, 2014

(30) Foreign Application Priority Data
Mar. 14, 2012 (JP) 2012-056773

(51) Int. Cl. F02P 5/04; G01M 15/11

(52) U.S. Cl. CPC F02P 5/04; G01M 15/11
USPC 701/111

(57) ABSTRACT

Knocking and misfire are judged by detecting combustion ions generated in a combustion chamber with an ion sensor, obtaining an integral signal by integrating the ion signal, and comparing the integral signal with a misfire judgment value and a knocking judgment value based on a signal obtained by averaging integral signals of prescribed past cycles. It is possible to: reduce a computation load by detecting misfire and knocking with an identical ion sensor and carrying out a judgment treatment with identical judgment function logic; and detect trace knocking by setting a knocking judgment threshold value and hence increase the accuracy of ignition timing control.

### TECHNICAL FIELD

The present invention relates: to a control device for an internal combustion engine; and in particular to a control device for an internal combustion engine that makes it possible to accurately estimate a knocking state and a misfire state of the internal combustion engine by detecting a combustion state in a cylinder as an ion signal.

### BACKGROUND ART

In recent years, attempts to improve the combustion efficiency of an internal combustion engine in order to improve the fuel efficiency of an automobile have been carried out. One of such improvement technologies is to increase a compression ratio and it is theoretically verified that the thermal efficiency of an internal combustion engine improves by increasing the compression ratio of the internal combustion engine.

Since a compression ratio is set at about 10 in the case of a spark-ignited internal combustion engine that uses gasoline and about 18 in the case of a diesel internal combustion engine, the thermal efficiency of a diesel internal combustion engine is allegedly higher than that of a spark-ignited internal combustion engine. In the case of a spark-ignited internal combustion engine that uses gasoline, if a compression ratio is increased in order to increase a combustion efficiency, abnormal combustion called knocking tends to occur in accordance with the increase of the compression ratio and hence the increase of a compression ratio itself is allegedly limited.

As a technology for inhibiting knocking, proposed is a method for reducing knocking by using an exhaust gas recirculation technology (usually called EGR), thus refluxing an exhaust gas to an intake gas side and reintroducing the exhaust gas into a combustion chamber, and thereby mitigating the combustion.

The technology aims to inhibit knocking from occurring by taking inert ingredients such as carbon dioxide and nitrogen oxide contained in an EGR gas into a combustion chamber abundantly, thus increasing the quantity of a working medium not contributing to combustion to air, thereby mitigating combustion reaction, and reducing a combustion speed.

In an internal combustion engine of a high compression ratio too, it is possible to: inhibit knocking from occurring by adopting the exhaust gas recirculation technology; and hence increase a compression ratio to about 14. Further, the method can also be applied to a supercharged internal combustion engine.

Meanwhile, it is reported that, by the method of reintroducing and combusting an EGR gas, combustion troubles such as combustion stop on the way and failure in combustion initiation caused by the deterioration of the ignition performance of an ignition plug and the reduction of a combustion speed occur if the EGR gas enters in excess of a defined quantity and resultantly the quality of the combustion deteriorates and the variation of the combustion quality in a combustion cycle increases.

Consequently, it is necessary to detect knocking as abnormal combustion and misfire that causes combustion variation in order to increase the compression ratio of an internal combustion engine by using an exhaust gas recirculation technology. It is difficult to increase the compression ratio of an internal combustion engine unless at least such knocking and misfire are avoided.

As a method for detecting knocking as abnormal combustion and misfire that causes combustion variation, a technology of judging misfire and knocking in an ignition coil and outputting the judgment result to the side of a control device is proposed as Japanese Unexamined Patent Publication No. H11 (1999)-159431 (Patent Literature 1) describes.

It is the that, by the technology, a detection circuit for misfire and a detection circuit for knocking are installed individually, the respective detection results are outputted as voltage values such as 5 V in misfire, 2.5 V in normal combustion, and 0 v in knocking, and a control device can judge the misfire and the knocking from the voltage values.

### CITATION LIST

### Patent Literature

Patent Literature 1: Japanese Unexamined Patent Application Publication No. H11 (1999)-159431

### SUMMARY OF INVENTION

### Technical Problem

Firstly before the present invention is explained, a conventional knocking detection method and the problems thereof are explained in reference to a drawing. FIG. 1 shows the configuration of a control device for an internal combustion engine and a conventional knocking detection method and a conventional misfire detection method are explained with the drawing.

Knocking and misfire are explained here and FIG. 1 will be explained further in detail when examples of the invention are explained later.

In FIG. 1, the reference numeral 9 represents a knocking sensor and the knocking sensor 9 captures pressure oscillation accompanying knocking occurring in a combustion chamber as the mechanical vibration of a cylinder block in an internal combustion engine.

The knocking sensor 9 detects not only the vibration by knocking but also various kinds of mechanical vibrations transmitting in a cylinder block in an internal combustion engine and hence a control device 1 applies frequency analysis to the detected vibrations, extracts only a knocking component, and judges the existence of the knocking.

The reference numeral 11 represents a toothed plate attached to a crank shaft synchronizing with the movement of a piston 12 and has sixty teeth at the crank angles of 6 degrees for example. The reference numeral 10 represents a crank angle sensor and the crank angle sensor 10 detects the teeth of the toothed plate 11 and transmits an angle signal and a reference signal to the control device 1. A crank angle and the rotational frequency of an internal combustion engine are computed on the basis of the signals in the control device 1. The computed values are used for the control of various kinds of actuators in the internal combustion engine, the injection control of a fuel injection valve 4, and the ignition control of an ignition plug 7.

If misfire occurs, it appears as a trifle variation of the rotational frequency in a combustion cycle and hence a method of computing the variation of the rotational frequency (angular speed) and judging it as the misfire is used. In this way, the occurrence of knocking is detected by applying frequency analysis to a signal from a knocking sensor and the occurrence of misfire is detected by obtaining an angle difference from an angle signal transmitted from a toothed plate. A problem of the two detection methods explained above is that knocking and misfire are detected by using different sensors and different detection mechanisms and hence the computation load in the control device 1 is high.

Further, in the technology described in Patent Literature 1, a simple configuration of obtaining signal outputs corresponding to misfire and knocking in an ignition coil and outputting the signals to the control device side is proposed. That is, a detection circuit for misfire and a detection circuit for knocking are installed, the respective detection results are outputted as the voltage values of 5 V in misfire, 2.5 V in normal combustion, and 0 V in knocking, and the misfire and the knocking are judged from the voltage values in the control device. In the technology described in Patent Literature 1 however, only the existence of knocking is judged and the continuous variation of knocking intensity cannot be detected.

As a result, a state of “trace knocking” that is an intermediate state between normal combustion (no knocking) and heavy knocking cannot be detected now and the technology is allegedly insufficient from the viewpoint of optimum control for the improvement of fuel efficiency.

Further, the ignition timing of an internal combustion engine is desirably set in the vicinity of a minimum spark advance for best torque (MBT) in order to improve fuel efficiency and, in order to prevent knocking from occurring, usually the ignition timing is set in the manner of providing a range in the direction of delaying the ignition timing from MBT timing in many cases. It is effective to reduce the range in the direction of delaying the ignition timing from the viewpoint of improving the efficiency of an internal combustion engine but it is necessary to detect trace knocking (region between normal combustion having no knocking and heavy knocking) in order to do so.

A prime object of the present invention is to provide a control device for an internal combustion engine that can judge the detection of misfire and the detection of knocking by identical judgment function logic of a low computation load and moreover can detect trace knocking.

### Solution to Problem

A feature of the present invention is to detect combustion ions generated in a combustion chamber with an ion sensor, obtain an integral signal by integrating an ion signal, and judge knocking and misfire by comparing the integral signal with a misfire judgment value and a knocking judgment value based on a signal obtained by averaging integral signals of prescribed past cycles.

### Advantageous Effects of Invention

The present invention makes it possible to: reduce a computation load by detecting a misfire state and a knocking state of combustion in an internal combustion engine with an identical ion sensor and carrying out a judgment treatment with identical judgment function logic; and moreover detect trace knocking by setting a knocking judgment threshold value and hence increase the accuracy of ignition timing control.

### BRIEF DESCRIPTION OF DRAWINGS

FIG. 1 is a configuration diagram of an internal combustion engine system to which a control device for an internal combustion engine according to the present invention is applied.

FIG. 2 is a configuration diagram showing the configuration and the input-output relation of a control device for an internal combustion engine according to an example of the present invention.

FIG. 3 is a graph showing the measurement result of an ion signal generated by combustion in a cylinder.

FIG. 4 is a characteristic diagram for explaining the generation status of an ignition signal and an ion signal and a region where the ion signal is used.

FIG. 5 is a characteristic diagram for explaining the relationship between an ion signal integral value and an internal combustion engine torque.

FIG. 6 is a characteristic diagram for explaining the relationship between an ion signal integral value and a knocking intensity.

FIG. 7 is an explanatory graph for explaining a judgment method of misfire and knocking.

FIG. 8 is a flowchart showing a control flow for carrying out the example shown in FIG. 2.

FIG. 9 is a configuration diagram showing the configuration and the input-output relation of a control device for an internal combustion engine according to another example of the present invention.

FIG. 10 is a characteristic diagram for explaining the generation status of an ignition signal and an ion signal and a region where the ion signal is used in the example shown in FIG. 9.

FIG. 11 is a flowchart showing a control flow for carrying out the example shown in FIG. 9.

FIG. 12 is a first time chart for explaining the judgment treatment of an ion signal.

FIG. 13 is a second time chart for explaining the judgment treatment of an ion signal.

FIG. 14 is a third time chart for explaining the judgment treatment of an ion signal.

FIG. 15 is a fourth time chart for explaining the judgment treatment of an ion signal.

### DESCRIPTION OF EMBODIMENTS

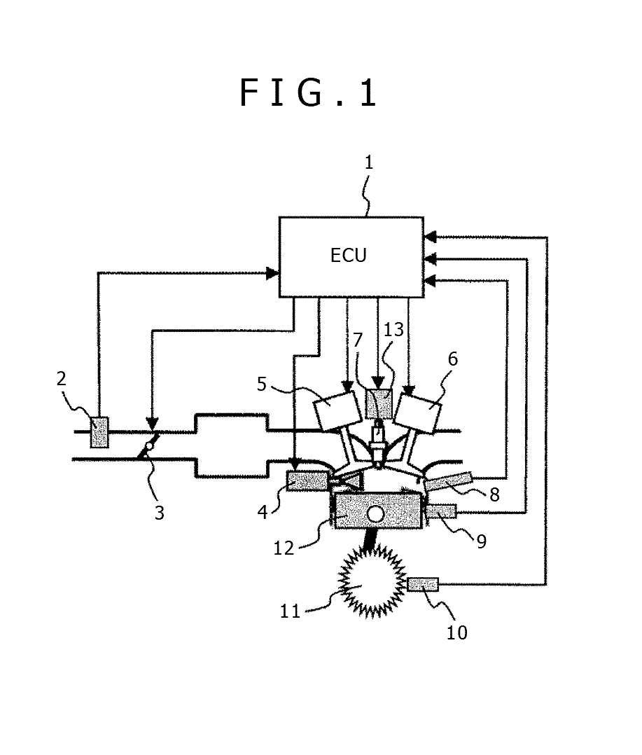

An example according to the present invention is hereunder explained in detail in reference to drawings. FIG. 1 shows the overall system of an internal combustion engine to which the present invention is applied.

In FIG. 1, the reference numeral 1 is a control device for an internal combustion engine and is configured so that signals from an air quantity sensor 2, an ion sensor 8, a knocking sensor 9, a crank angle sensor 10 and other sensors not shown in the figure may be inputted into the control device 1. The inputted signals are used for computing the controlled variables of various kinds of control actuators by a computer or the like incorporated into the control device 1 and the controlled variables computed here are outputted to the control actuators.

Concretely, the control device 1 is configured so as to output the control signals to a throttle valve 3, a fuel injection valve 4, an intake variable valve 5, an exhaust variable valve 6, and an ignition coil 13 to apply a high voltage to an ignition plug 7.

The basic control and others of the various actuators are known well and hence detailed explanations are omitted here. Then examples according to the present invention are explained hereunder.

### Example 1

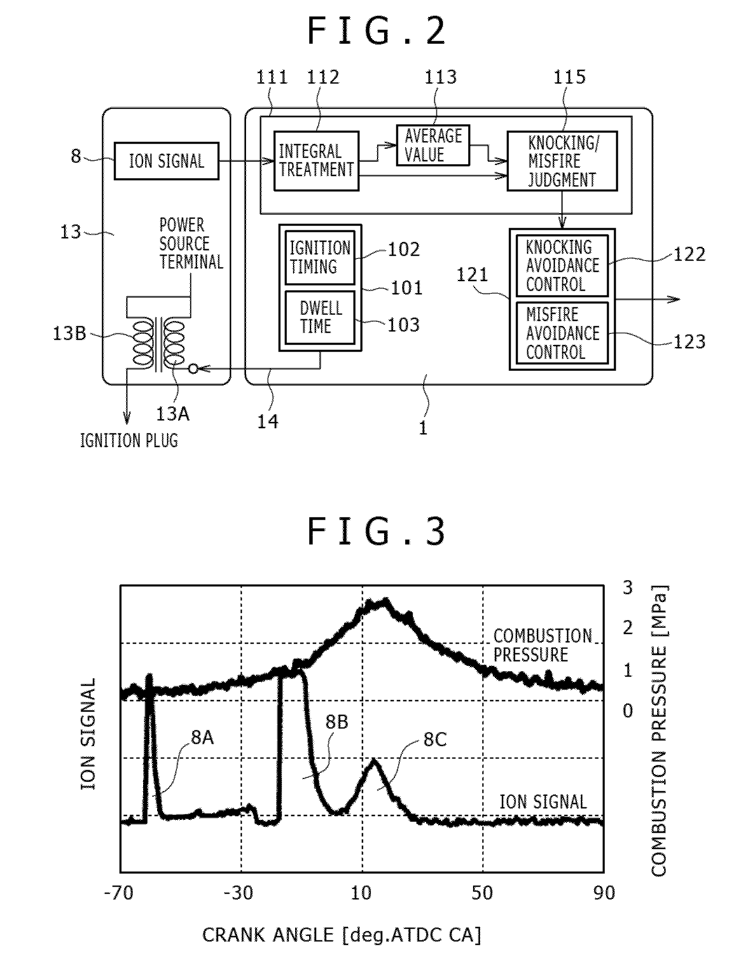

FIG. 2 is a diagram showing treatment blocks of input-output signals of a control device for an internal combustion engine (hereunder referred to merely as a control device) according to an example of the present invention. Ina control device 1, on the basis of input signals from various sensors, an ignition timing is computed at an ignition timing computation block 102, a dwell time of primary current that is energy necessary for ignition is computed at a dwell time computation block 103, and an ignition signal 14 formed by pairing the ignition timing and the dwell time is outputted to an ignition coil 13.

The ignition coil 13 comprises a primary coil 13A and a secondary coil 13B and is configured so that a power source may be connected to the top end of the primary coil 13A and the ignition signal 14 may be inputted into the bottom end thereof. The detailed description on a drive circuit such as a transistor generally used is omitted here.

The top end of the secondary coil 13B is connected to the power source and the bottom end thereof is connected to an ignition plug 7. When the ignition signal 14 is inputted, the primary coil 13A starts to be charged and is charged for a prescribed period of time (generally crank angle equivalent).

Successively, when the dwell time finishes, a high voltage is generated at the secondary coil 13B in accordance with the interruption of the ignition signal 14, the ignition plug 7 sparks by the generated high voltage, and an air-fuel mixture in a cylinder is ignited.

The spark ignites the air-fuel mixture in a combustion chamber formed in the cylinder, thus combustion starts, and the pressure in the combustion chamber increases, thereby pushes up a piston 12, rotates a crank shaft connected to the piston 12, and is taken out as the rotation output of an internal combustion engine.

The rotational frequency of the crank shaft is inputted into the control device 1 by detecting the number of teeth formed at a toothed plate 11 fixed to the crank shaft with a crank angle sensor 10.

Successively, a method for detecting an ion signal is explained hereunder. Many ions exist as an intermediate product in a combustion flame generated by igniting an air-fuel mixture in a combustion chamber. A signal from an ion sensor 8 to detect the ions is inputted into a control device 1 and the generation status of misfire and knocking is judged by an ion signal treatment means 111.

Although an ion signal can be detected in various forms, an example of detecting an ion signal as an electric current is disclosed here. A method for representing an ion signal as an electric current is publicly known and hence the explanation is omitted here.

In the ion signal treatment means 111, firstly an ion signal itself is subjected to an integral treatment at an ion signal integral treatment block 112. On this occasion, the ion signal is subjected to an integral treatment without passing through a band-pass filter or the like. This is a pretreatment for correlating the sum of ion components generated by combustion to a combustion state.

That is, combustion continues over a prescribed period of time, but abnormal combustion such as the case where combustion is normal at first but the combustion is interrupted in the second half may occur occasionally, and hence it is necessary to monitor combustion over the combustion period in order also to detect such combustion. Here, although it will be described later, the combustion period may not be an entire combustion period and may also be a selected period where actually a combustion pressure increases and descends afterward in accordance with the progress of combustion.

Here, a signal outputted from the ion signal integral treatment block 112 is referred to as an ion signal integral value. An ion signal integral value is inputted into an ion signal average value computation treatment block 113 having a storage section comprising a semiconductor memory and others and a value obtained by adding integral values of ion signals generated in past several combustion cycles and dividing the added integral values by the number of the cycles is outputted as an average value of the ion signal integral values.

This is referred to as a background level of an ion signal (this comes to be a basis of a knocking judgment value), the background level is inputted into a misfire/knocking judgment block 115 and is compared with an ion signal integral value at the time, and thus the generation state of knocking is judged. The treatment in the misfire/knocking judgment block 115 is described later.

Here, in the computation of a background level used for judgment at the misfire/knocking judgment block 115, the ion signal integral value judged this time is not used and the ion signal integral values of several cycles including the ion signal integral value judged last time are used. Consequently, the ion signal integral value judged this time is used for computing the next background level.

Then, when knocking is judged to occur at the misfire/knocking judgment block 115, the knocking is avoided by applying a treatment of delaying an ignition timing or the like at a knocking avoidance control block 122 or, when misfire is judged to occur at the misfire/knocking judgment block 115, a treatment of avoiding the misfire is applied by increasing the concentration of an air-fuel mixture or increasing the quantity of an air-fuel mixture at a misfire avoidance control block 123.

FIG. 3 shows the measurement result of an ion signal outputted from an ion sensor 8 together with the waveform of a pressure in a combustion chamber for comparison. As it is obvious from FIG. 3, the ion signal is characterized by having three peaks.

A first peak 8A is a waveform seen in the case where the ion sensor 8 is incorporated into an ignition coil 7. An electric current flows in a detection section of the ion sensor 8 when an ignition signal 14 is inputted and is outputted as an ion signal. The peak 8A appears actually at a timing when a combustion flame does not exist in a combustion chamber and hence it is necessary to treat the peak 8A as a noise.

A second peak 8B is a waveform seen after an ignition signal 14 is interrupted and a spark flies in the gap of an ignition plug 7 and, although an ion signal is not detected during the time when a spark flies in a gap, afterward an ion component in a flame at the initial stage of combustion is detected. The second peak 8B is however not correlated with a combustion pressure, can hardly capture combustion accurately, and cannot be used for detecting knocking and misfire.

A third peak 8C is a waveform detected during the process where a combustion flame spreads in a whole combustion chamber, well coincides with a pressure waveform in the combustion chamber, and hence is allegedly used for detecting an ion component in a flame at a primary combustion part.

In the present invention, the third peak 8C is set at a prescribed combustion period, a combustion state is estimated by an ion signal, and thus the third peak 8C is used for judging knocking and misfire.

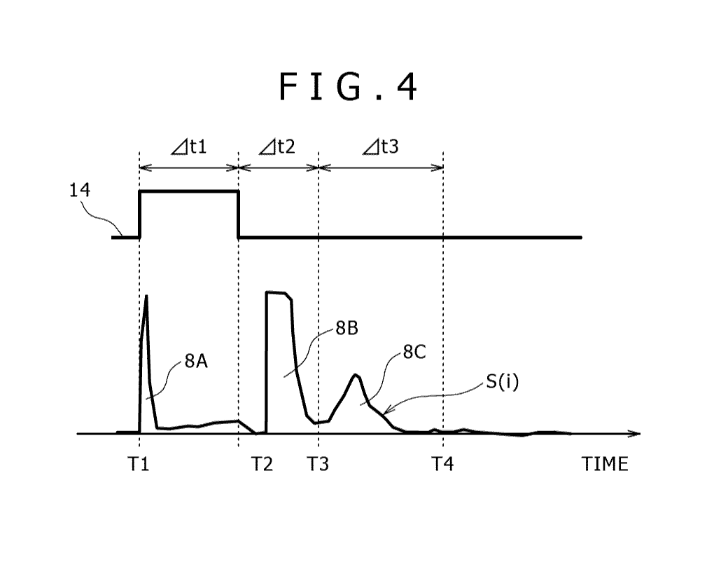

FIG. 4 shows the relationship between an ignition signal 14 and an ion signal 8. An ignition signal 14 is inputted at a time T1 and electric charge for accumulating ignition energy in a primary coil 13A starts. On that occasion, a first peak 8A having a noise waveform explained in FIG. 3 is observed. The peak 8A is a noise caused by the ignition signal as stated earlier and hence is not used for detecting knocking and misfire.

The ignition signal 14 is interrupted at a time T2 after the lapse of a dwell time Δt1 and a second peak 8B is observed during a time period Δt2 after the interruption of the ignition signal 14. The peak 8B however has no correlation with a combustion pressure as stated earlier and does not represent an accurate combustion state and hence the peak 8B also is not used for detecting knocking and misfire.

On the other hand, a third peak 8C ranging from a time T3 after the lapse of the time period Δt2 to a time T4 after the lapse of a time period Δt3 is well correlated with a combustion pressure and well represents a combustion state. Thus, the peak 8C is sampled sequentially over the time period Δt3 and sent to an ion signal integral treatment block 112 and an ion signal integral value is computed at the ion signal integral treatment block 112.

When this is defined as an ion signal integral value S(i) at this time, at an ion signal average value computation treatment block 113, past ion signal integral values accumulated in the interior, namely including a last time ion signal integral value S(i−1), an ion signal integral value two times ago S(i−2), anion signal integral value three times ago S(i−3), and etc., are subjected to an averaging treatment and outputted as a background level and this is defined as a background level Sh. The background level Sh is used for detecting knocking.

The number of ion signal integral values used for the averaging treatment corresponds to several cycles and is decided to the extent not exceeding 10 cycles.

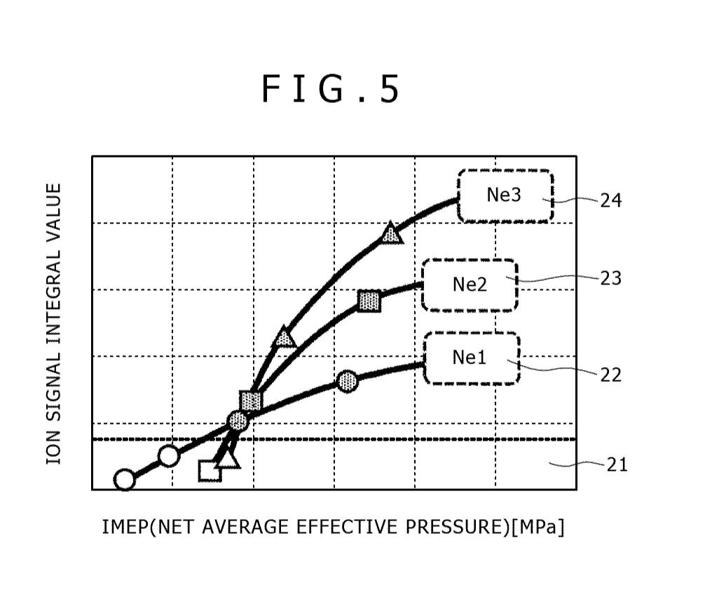

FIG. 5 shows the results of detecting misfire in the present example shown in FIG. 2 and in particular shows the results verified in a normal operation state. The horizontal axis in the graph represents a net average effective pressure as a torque of an internal combustion engine and the vertical axis represents an ion signal integral value.

In FIG. 5, the reference numeral 22 shows a region where stable rotation can be obtained at a rotational frequency Ne1, the reference numeral 23 shows a region where stable rotation can be obtained at a rotational frequency Ne2, and likewise the reference numeral 24 shows a region where stable rotation can be obtained at a rotational frequency Ne3.

Consequently, the regions 22 to 24 show background levels Sh in the operation states of the rotational frequencies Ne1 to Ne3. A background level Sh is an average of the ion signal integral values of past several cycles and hence no large variation appears in a steady state. As a result, a combustion state falls within the regions 22 to 24 when the combustion state is stable.

If misfire occurs in such a state, a combustion flame does not exist in a combustion chamber or, even when a combustion flame exists, the combustion flame is weak and hence an ion signal integral value S(i) at the combustion cycle reduces and, when the combustion state falls within a predetermined region 21, the combustion state can be judged as misfire.

As shown in FIG. 5, as combustion shifts toward a destabilized state, the ion signal integral value of each rotational frequency reduces and, when the combustion state gets into the region 21, the combustion is destabilized considerably and hence the combustion state is judged as misfire.

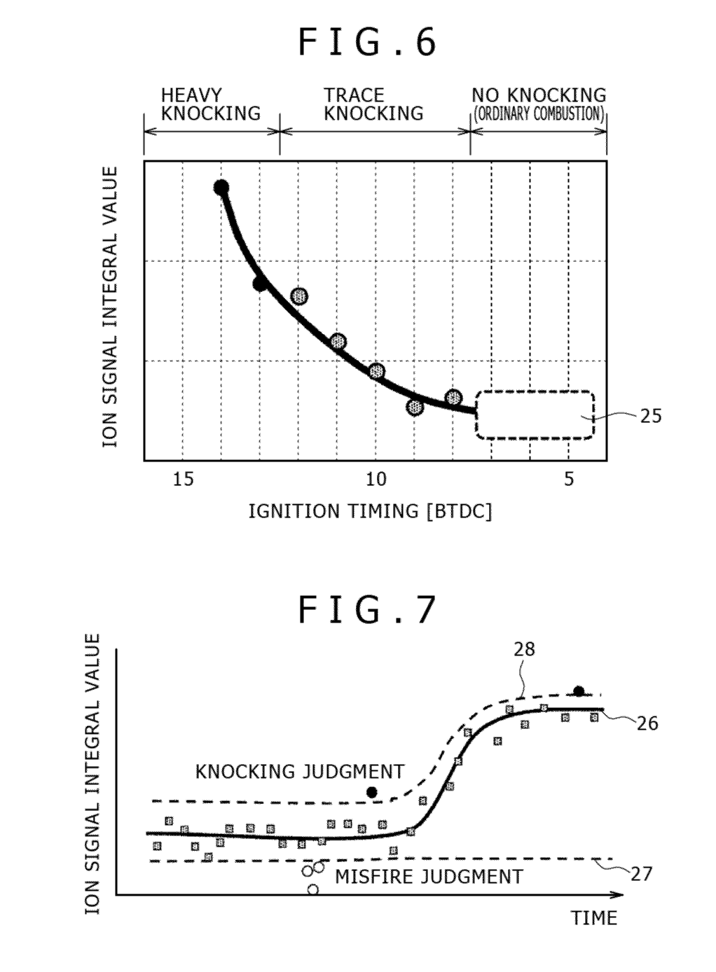

FIG. 6 shows the result of detecting knocking in the present example shown in FIG. 2 likewise and is the result verified in normal operation. The horizontal axis of the graph represents an ignition timing as a knocking intensity and the knocking intensity is changed by controlling the ignition timing in the experiment and the vertical axis represents an ion signal integral value.

As an ignition timing shifts toward the left in the graph, the ignition timing advances, hence a knocking intensity increases, and the leftmost section represents the state of generating heavy knocking. A region 25 shows a region of an ordinary combustion state at a prescribed rotational frequency Ne here too and the region represents the state of a so-called no-knocking background level Sh.

Here, when an ignition timing advances, knocking starts to appear and the waveform of an ion signal representing the combustion state in a combustion chamber starts to change. An ion signal integral value also changes in proportion to the change of a knocking intensity and a sufficient sensitivity is secured from a trace knocking region to a heavy knocking region. That is, when an ignition timing advances sequentially from an ordinary combustion region 25 where knocking does not occur, an ion signal integral value also increases in accordance with that and gets into a heavy knocking region and hence it is sufficiently possible to detect trace knocking during this time.

For example, when knocking occurs in the operation state of the region 25, pressure/temperature in a combustion chamber increase and thus an ion signal integral value S(i) increases and takes a value exceeding a background level Sh.

It is possible to judge knocking by setting a value obtained by adding a prescribed value to a background level Sh or a value obtained by multiplying a background level Sh by a prescribed ratio (coefficient of not less than 1.0) as a knocking judgment threshold value. Further, since an allowable knocking intensity varies in conformity with an individual operation state of an internal combustion engine, it is also possible to adopt a method of storing a knocking judgment threshold value in a memory and referring to the knocking judgment threshold value in an individual operation state.

FIG. 7 is a verification result obtained when knocking detection and misfire detection are carried out simultaneously in the example shown in FIG. 2. The horizontal axis represents a time and a state where an operation state changes moderately is shown and the vertical axis represents an ion signal integral value.

In FIG. 7, a symbol □ represents a normal ion signal integral value S(i) where neither knocking nor misfire occurs and every symbol □ falls within a prescribed range around a background level Sh 26. In FIG. 7 further, a misfire judgment threshold value is represented by a broken line 27 and an ion signal integral value S(i) lower than the value is represented by a symbol ◯ and judged as misfire.

In FIG. 7 furthermore, a broken line 28 represents a knocking judgment threshold value, the value is obtained by adding a prescribed value or being multiplied by a prescribed coefficient in conformity with a background level Sh as stated earlier, and hence the value changes in conformity with the background level Sh. Then, an ion signal integral value S(i) exceeding the knocking judgment threshold value is represented by a symbol • and judged as knocking.

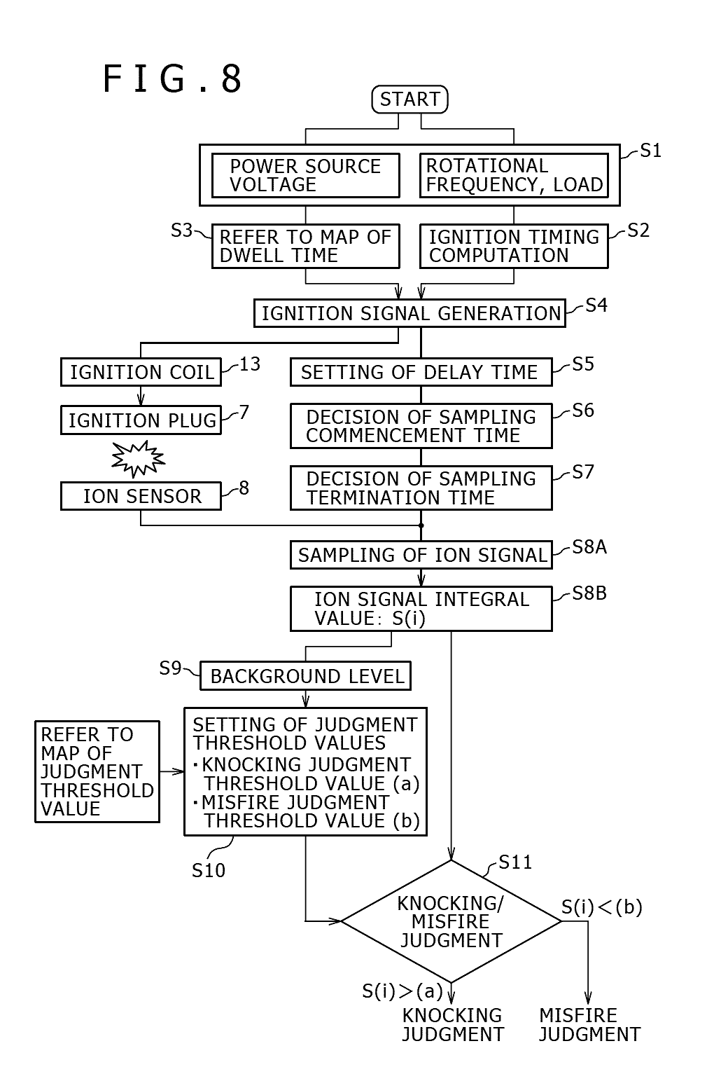

In FIG. 8, a flowchart of misfire/knocking judgment for carrying out the example shown in FIG. 2 is shown.

Firstly, a control device 1 reads an operation state, such as a power source voltage, a rotational frequency, a load, and others, of an internal combustion engine on the basis of signals from various kinds of sensors at Step 1 (hereunder Step is referred to as “S”), forwards the procedure to S2, and computes an ignition timing from those signals. Simultaneously, a dwell time is obtained by computing the dwell time or referring to a map at S3.

Successively, the procedure advances to S4 and an ignition signal is produced and is outputted to an ignition coil 13. Successively, ignition operation is carried out with an ignition plug 7.

Successively at S5, a delay time Δt2 after the interruption of the ignition signal shown in FIG. 4 is set by using the way of thinking shown in FIG. 4. Successively at S6, a sampling commencement time T3 of an ion signal is decided and, further at S7, a termination time T4 is decided. Through those steps, such an ion signal including a third peak 8C as shown in FIG. 4 is taken in.

Consequently, a signal detected by an ion sensor 8 since the end of ignition operation is sampled over a decided time period between the sampling commencement time T3 and the sampling termination time T4 at S8A and successively an on signal integral value (Si) is computed by integrating the sampled ion signal between the time T3 and the time T4 at S8B.

Successively at S9, a background level Sh is computed by applying an averaging treatment. The background level Sh is a value obtained by, as stated earlier, adding the integral values of ion signals generated in past several combustion cycles and dividing the added integral values by the number of the cycles and is outputted as the average value of the ion signal integral values.

Here, in the computation of a background level Sh, the ion signal integral value judged this time is not used and ion signal integral values of several cycles including the ion signal integral value judged last time are used. Consequently, the ion signal integral value judged this time is used for computing the next background level.

Successively at S10, a knocking judgment threshold value (a) and a misfire judgment threshold value (b) are set in accordance with the operation state of an internal combustion engine. The methods for deciding the knocking judgment threshold value (a) and the misfire judgment threshold value (b) are as explained earlier. Here, the knocking judgment threshold value (a) and the misfire judgment threshold value (b) may also refer to predetermined map values.

Successively at S11, the ion signal integral value S (i) this time is compared with the knocking judgment threshold value (a) and the misfire judgment threshold value (b) and is judged as knocking or misfire when it conforms to respective judgment conditions.

The present invention represented by the present example makes it possible to: reduce a computation load by detecting a misfire state and a knocking state of combustion in an internal combustion engine with an identical ion sensor and carrying out a judgment treatment with identical judgment function logic; and moreover detect trace knocking by setting a knocking judgment threshold value and hence increase the accuracy of ignition timing control.

### Example 2

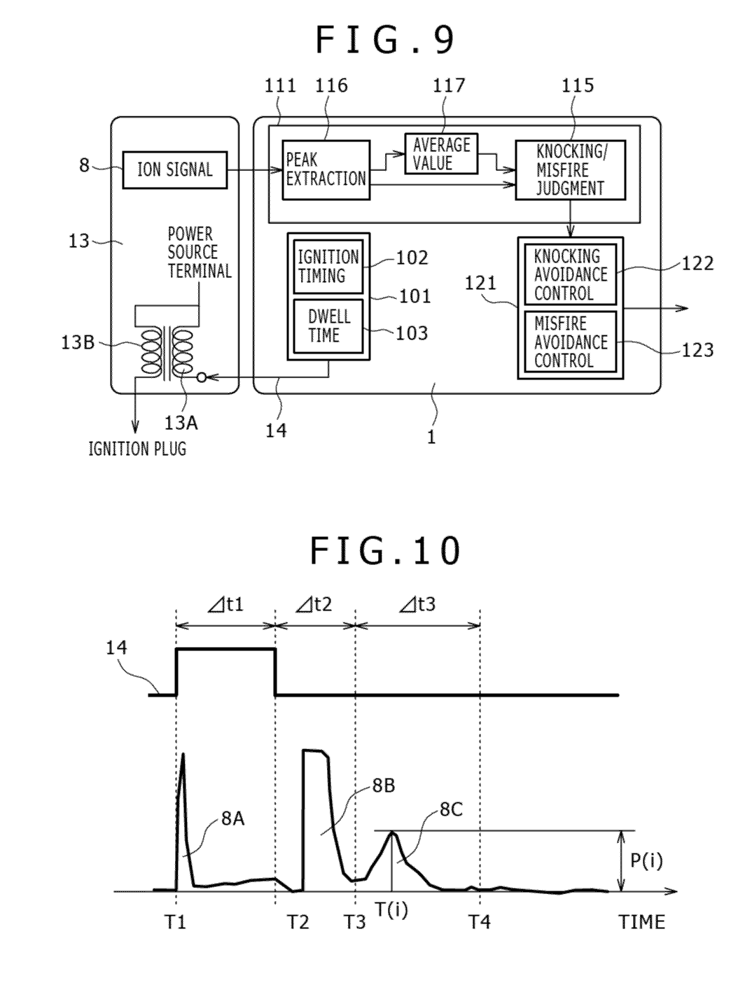

Another example according to the present invention is hereunder explained in detail in reference to drawings. FIG. 9 shows a configuration of changing an ion signal integral treatment block 112 of an ion signal treatment means 111 shown in Example 1 to an ion signal peak detection block 116.

The operation in the second example is substantially identical to Example 1 basically but is different on the point that an ion signal peak value detection block 116 is used as stated above.

Then the operation is briefly explained as follows. FIG. 10 shows a waveform of the same ion signal as FIG. 4 and represents the relationship between an ignition signal 14 and an ion signal 8. An ignition signal 14 is inputted at a time T1 and electric charge for accumulating ignition energy in a primary coil 13A starts. On that occasion, a first peak 8A having a noise waveform explained in FIG. 3 is observed. The peak 8A is a noise caused by the ignition signal as stated earlier and hence is not used for detecting knocking and misfire.

The ignition signal 14 is interrupted at a time T2 after the lapse of a dwell time Δt1 and a second peak 8B is observed during a time period Δt2 after the interruption of the ignition signal 14. The peak 8B however has no correlation with a combustion pressure as stated earlier and does not represent an accurate combustion state and hence the peak 8B also is not used for detecting knocking and misfire.

On the other hand, a third peak 8C ranging from a time T3 after the lapse of the time period Δt2 to a time T4 after the lapse of a time period Δt3 is well correlated with a combustion pressure and hence well represents a combustion state. Thus, the peak 8C is sampled sequentially over the time period Δt3 and a peak value of the ion signal is extracted at the ion signal peak detection block 116 and is used as an ion signal peak value P(i).

At an ion signal peak value average treatment block 117, ion signal peak values P(i−1), P(i−2), P(i−3), and etc. of past combustion cycles accumulated in the interior are subjected to an averaging treatment and are outputted as a background level Ph.

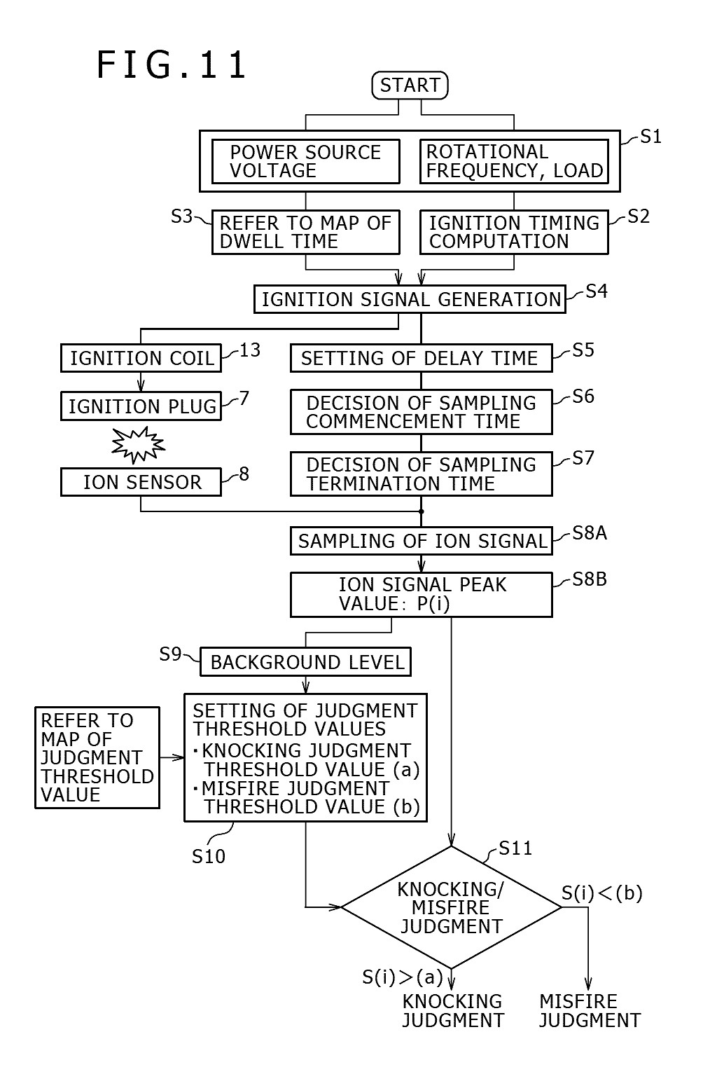

In FIG. 11, a flowchart of misfire/knocking judgment for carrying out the example shown in FIG. 9 is shown.

Firstly, an operation state, such as a power source voltage, a rotational frequency, a load, and others, of an internal combustion engine is read on the basis of signals from various kinds of sensors at S1, the procedure proceeds to S2, and an ignition timing is computed from those signals. Simultaneously, a dwell time is obtained by computing the dwell time or referring to a map at S3.

Successively, the procedure advances to S4 and an ignition signal is produced and is outputted to an ignition coil 13. Successively, ignition operation is carried out with an ignition plug 7.

Successively at S5, a delay time Δt2 after the interruption of the ignition signal shown in FIG. 4 is set by using the way of thinking shown in FIG. 10. Successively at S6, a sampling commencement time T3 of an ion signal is decided and, further at S7, a termination time T4 is decided. Through those steps, such an ion signal including a third peak 8C as shown in FIG. 10 is taken in.

Consequently, a signal detected by an ion sensor 8 since the end of ignition operation is sampled over a decided time period between the sampling commencement time T3 and the sampling termination time T4 at S8A and successively an ion signal peak value (Pi) sampled between the time T3 and the time T4 is obtained at S8B.

Successively at S9, a background level Ph is computed by applying an averaging treatment. The background level Ph is a value obtained by, in the same way as Example 1, adding the peak values of ion signals generated in past combustion cycles and dividing the added peak values by the number of the cycles and is outputted as the average value of the ion signal peak values.

Here, in the computation of a background level Ph, the ion signal peak value judged this time is not used and ion signal peak values of several cycles including the ion signal peak value judged last time are used. Consequently, the ion signal peak value judged this time is used for computing the next background level.

Successively at S10, a knocking judgment threshold value (a) and a misfire judgment threshold value (b) are set in accordance with the operation state of an internal combustion engine. The methods for deciding the knocking judgment threshold value (a) and the misfire judgment threshold value (b) are as explained earlier. Here, the knocking judgment threshold value (a) and the misfire judgment threshold value (b) may also refer to predetermined map values.

Successively at S11, the ion signal peak value P(i) this time is compared with the knocking judgment threshold value (a) and the misfire judgment threshold value (b) and is judged as knocking or misfire when it conforms to respective judgment conditions.

In this way, by not integrating an ion signal but using a peak signal, an additional effect that the computation load of a control device can be further reduced is expected in addition to the effects of Example 1.

Here, although an ion signal peak value detection block 116 is used in Example 2 in place of an ion signal integral treatment block 112, it is also possible to detect knocking and misfire by using both an ion signal integral treatment block 112 and an ion signal peak value detection block 116.

For example, abnormal combustion is estimated to occur even when a peak value does not reach a prescribed judgment threshold value and this can be judged by an ion signal integral value. Likewise, abnormal combustion is estimated to occur even when an integral value does not reach a prescribed judgment threshold value and this can be judged by an ion signal peak value.

A method for the judgment treatment of an ion signal waveform is explained hereunder and a treatment method in the case of using an ion signal integral value shown in Example 1 is explained in the following example.

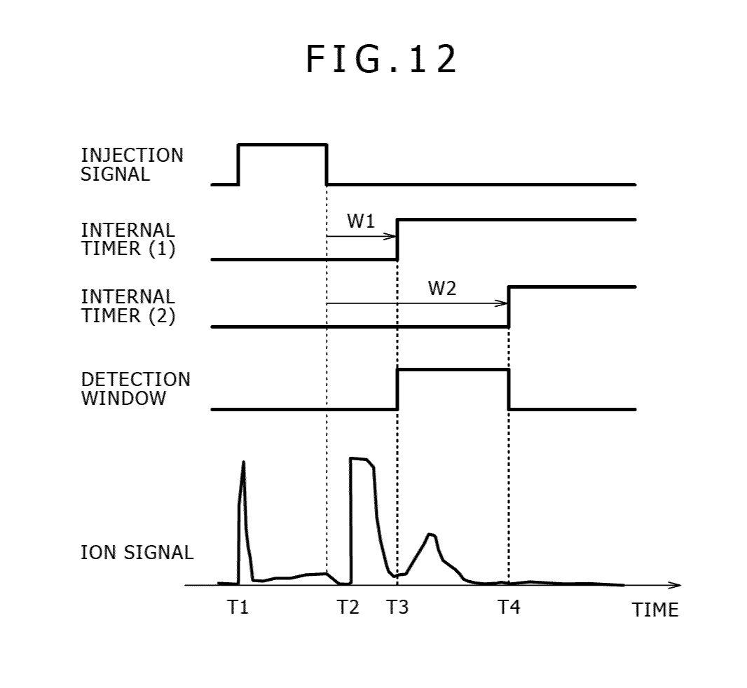

FIG. 12 shows the relationship between an ion signal and an ignition signal in a normal combustion state. At an ion signal treatment means 111, a detection window is set by deciding a time period W1 and a time period W2 with an internal timer 1 and an internal timer 2 after an ignition signal 14 is interrupted.

The detection window corresponds to the time period between a time T3 and a time T4 and an ion signal integral value S(i) is obtained by integrating an ion signal in the detection window.

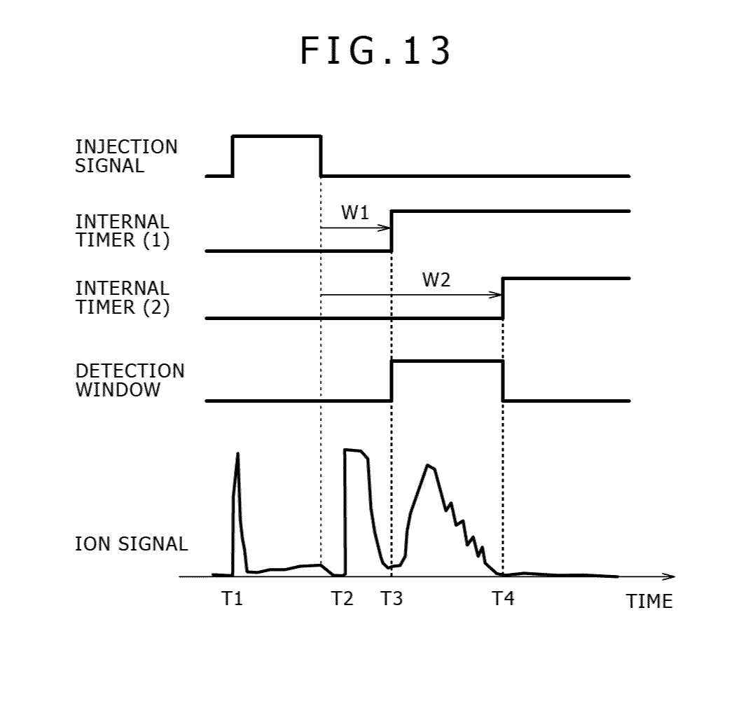

In contrast, FIG. 13 shows an ion signal appearing when knocking occurs and the area and the peak value of the ion signal itself increase. Consequently, an ion signal integral value also increases and this case is judged as knocking by the detection logic shown in FIG. 8.

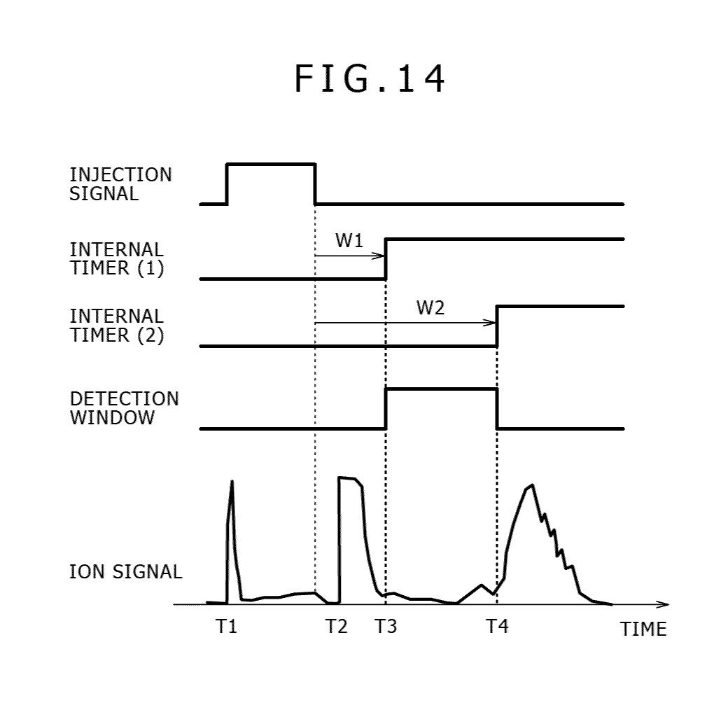

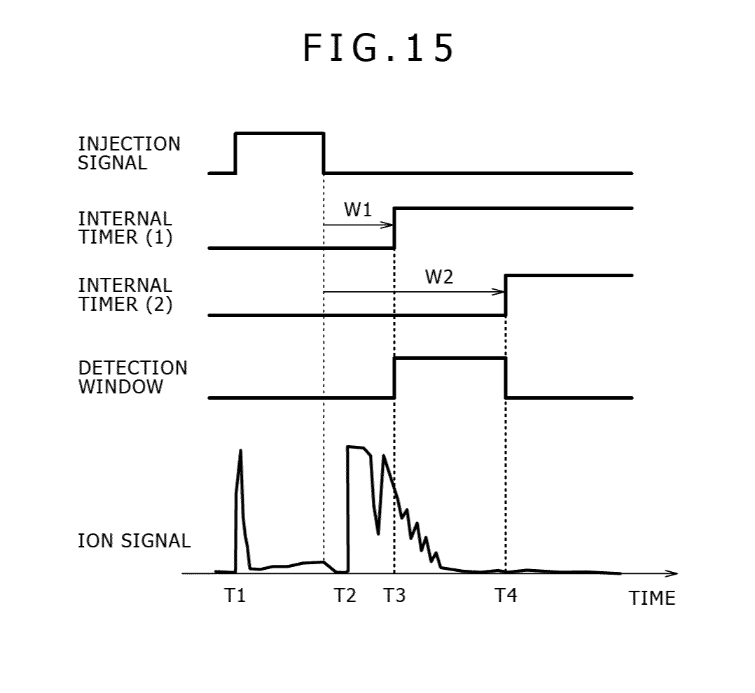

Meanwhile, in FIG. 14, an ion signal of the same extent as the case where knocking occurs is observed but deviates from a detection window, thus an ion signal integral value is small, and hence the case is not judged as knocking. In FIG. 15, an ion signal of the same extent as the case where knocking occurs is observed likewise but the generation time shifts forward, an ion signal integral value in a detection window is small, and hence the case is not judged as knocking.

As explained above, the present invention makes it possible to: reduce a computation load by detecting a misfire state and a knocking state of combustion in an internal combustion engine with an identical ion sensor and carrying out a judgment treatment with identical judgment function logic; and moreover detect trace knocking by setting a knocking judgment threshold value and hence increase the accuracy of ignition timing control.

### LIST OF REFERENCE SIGNS

1 Control device
2 Air quantity sensor
3 Throttle valve
4 Fuel injection valve
5 Intake variable valve
6 Exhaust variable valve
7 Ignition plug
8 Ion sensor
9 Knocking sensor
10 Crank angle sensor
11 Crank plate
12 Piston
13 Ignition coil
14 Ignition signal
21 Misfire judgment region
22, 23, 24, 25, 26 Background level
27 Misfire judgment threshold value
28 Knocking judgment threshold value
101 Ignition signal generation means
102 Dwell time decision section
103 Ignition timing decision section
111 Ion signal treatment means
112 Ion signal integral section
113 Ion signal integral value storage section
115 Misfire/knocking judgment section
116 Ion signal peak detection section
117 Ion signal peak value storage section
121 Actuator control means
122 Ignition control section
123 Variable valve control section

1. A control device for an internal combustion engine having: an ignition signal generation means to output an ignition signal including an ignition timing and a dwell time for a primary coil to an ignition coil in the internal combustion engine; an ion signal detection means to detect an ion signal generated in accordance with the combustion of an air-fuel mixture in a cylinder; an integral means, after the interruption of the ignition signal, to set a prescribed delay time and mask and integrate an ion signal caused by an initial flame in the ion signal; a background level generation means to average the integral values of ion signals of prescribed past combustion cycles and thus obtain a background level; and a knocking judgment means to compare a prescribed threshold value determined by the background level with an instant ion signal integral value and judge the case where the instant ion signal integral value exceeds the prescribed threshold value as knocking.

2. A control device for an internal combustion engine having: an ignition signal generation means to output an ignition signal including an ignition timing and a dwell time for a primary coil to an ignition coil in the internal combustion engine; an ion signal detection means to detect an ion signal generated in accordance with the combustion of an air-fuel mixture in a cylinder; an integral means, after the interruption of the ignition signal, to set a prescribed delay time and mask and integrate an ion signal caused by an initial flame in the ion signal; and a misfire judgment means to compare a prescribed threshold value predetermined for detecting misfire with an instant ion signal integral value and judge the case where the instant ion signal integral value exceeds the prescribed threshold value as misfire.

3. A control device for an internal combustion engine according to claim 1, wherein knocking judgment and misfire judgment are carried out through identical arithmetic processing.

4. A control device for an internal combustion engine having: an ignition signal generation means to output an ignition signal including an ignition timing and a dwell time for a primary coil to an ignition coil in the internal combustion engine; an ion signal detection means to detect an ion signal generated in accordance with the combustion of an air-fuel mixture in a cylinder; an ion signal peak value detection means, after the interruption of the ignition signal, to set a prescribed delay time, mask an ion signal caused by an initial flame in the ion signal, set a sampling commencement time and a termination time of the ion signal, and extract a peak value of the ion signal during the sampling period; a background level generation means to average the peak values of ion signals of prescribed past combustion cycles and thus obtain a background level; and a knocking judgment means to compare a prescribed threshold value determined by the background level with an instant ion signal peak value and judge the case where the instant ion signal peak value exceeds the prescribed threshold value as knocking.

5. A control device for an internal combustion engine having: an ignition signal generation means to output an ignition signal including an ignition timing and a dwell time for a primary coil to an ignition coil in the internal combustion engine; an ion signal detection means to detect an ion signal generated in accordance with the combustion of an air-fuel mixture in a cylinder; an integral means, after the interruption of the ignition signal, to set a prescribed delay time and mask and integrate an ion signal caused by an initial flame in the ion signal; an ion signal peak value detection means, after the interruption of the ignition signal, to set a prescribed delay time, set a sampling commencement time and a termination time of the ion signal, and extract a peak value of the ion signal during the sampling period; and a misfire judgment means to compare a prescribed threshold value predetermined for detecting misfire with an instant ion signal peak value and judge the case where the instant ion signal peak value exceeds the prescribed threshold value as misfire.

6. A control device for an internal combustion engine according to claim 4, wherein knocking judgment and misfire judgment are carried out through identical arithmetic processing.

7. A control device for an internal combustion engine according to claim 1, wherein an ignition timing is delayed by the ignition signal generation means when knocking is identified.

8. A control device for an internal combustion engine having:
an ignition signal generation means to output an ignition signal including an ignition timing and a dwell time for a primary coil to an ignition coil in the internal combustion engine;
an ion signal detection means to detect an ion signal generated in accordance with the combustion of an air-fuel mixture in a cylinder;
an integral means, after the interruption of the ignition signal, to set a prescribed delay time, mask and integrate an ion signal caused by an initial flame in the ion signal, and thus obtain an ion signal integral value;
a background level generation means to average the integral values of ion signals of prescribed past combustion cycles and thus obtain a background level; and
a knocking and misfire judgment means to compare the ion signal integral value with a predetermined misfire judgment value and a knocking judgment value based on the background level and judge knocking and misfire.

9. A control device for an internal combustion engine having:
an ignition signal generation means to output an ignition signal including an ignition timing and a dwell time for a primary coil to an ignition coil in the internal combustion engine;
an ion signal detection means to detect an ion signal generated in accordance with the combustion of an air-fuel mixture in a cylinder;
an ion signal peak value computation means, after the interruption of the ignition signal, to set a prescribed delay time, mask an ion signal caused by an initial flame in the ion signal, set sampling commencement and termination times, and extract a peak value of the ion signal during the sampling period;
a background level generation means to average the peak values of ion signals of prescribed past combustion cycles and thus obtain a background level; and
a knocking and misfire judgment means to compare the ion signal peak value with a predetermined misfire judgment value and a knocking judgment value based on the background level and judge knocking and misfire.

10. A control device for an internal combustion engine according to claim 8, wherein the predetermined misfire judgment value is decided in each operation region.

11. A control device for an internal combustion engine according to claim 8, wherein the prescribed delay time is set at a time that allows the peak of an ion signal appearing first after the interruption of the ignition signal to be masked.

12. A control device for an internal combustion engine according to claim 8, wherein the background level generation means yields the background level by dividing the integral values of ingested ion signals, the integral values of ion signals of prescribed combustion cycles ingested prior to peak values, the integral values of ion signals to which peak values are added, or peak values by the number of the prescribed combustion cycles.
